(19) United States
(12) Patent Application Publication
(10) Pub. No.: US 2024/0249216 A1
(43) Pub. Date: Jul. 25, 2024

(54) NON-FACE-TO-FACE ONLINE BUSINESS MATCHING SYSTEM AND METHOD

(71) Applicant: EASYTASK INC., Seoul (KR)

(72) Inventor: Hye Jin JEON, Seoul (KR)

(21) Appl. No.: 18/624,651

(22) Filed: Apr. 2, 2024

Related U.S. Application Data
(63) Continuation of application No. PCT/KR2022/014880, filed on Oct. 4, 2022.

(30) Foreign Application Priority Data
Oct. 6, 2021 (KR) 10-2021-0132039

(51) Int. Cl. G06Q 10/0631; G06Q 30/0204

(52) U.S. Cl. CPC G06Q 10/063112; G06Q 30/0204

(57) ABSTRACT

A non-face-to-face online business matching system includes a user (client) terminal connected to a service providing server through the Internet and configured to request a business, a service providing server configured to divide a business requested by the user (client) terminal into detailed businesses (tasks), analyze mutual requirements between a business requester and a business performer, selects a person (the business performer) capable of performing a related business, and assign the businesses, and a business performer terminal configured to receive the businesses assigned by the service providing server through the Internet, perform the businesses, derive a result, and provide the result to the user (client) terminal through the Internet.

### CROSS-REFERENCE TO RELATED APPLICATION

This application is a continuation of International Application No. PCT/KR2022/014880 filed on Oct. 4, 2022, which claims priority to Korean Patent Application No. 10-2021-0132039 filed on Oct. 6, 2021, the entire contents of which are herein incorporated by reference.

### BACKGROUND

### 1. Field

The present disclosure relates to a non-face-to-face online business matching system and method, and more particularly, to a non-face-to-face online business matching system and method that, when a user (client) requests a business, divides the business (task) into detailed businesses in a system, analyzes mutual requirements between the client and a business performer, assigns people (business performers) who may perform the businesses, and derives a result.

### 2. Description of the Related Art

When job seekers, employment agencies, and companies collect job opening/job search information, regular landline phones, cell phones, the Internet, and so on are widely used. With the development of the Internet, methods of job introduction or job provision using online platforms are proposed but are limited to simple introductions and are not operated efficiently. Therefore, it is necessary to provide a system that allows job seekers to find job (tasks) more easily without unnecessary waste of time and allows recruiters (or job requesters) to meet people who may perform jobs (tasks) required by the recruiters. In particular, a smart task platform is required that allows clients to perform works which may not be processed their own faster and more efficiently and provides workers with a familiar work environment and a variety of work experiences without unnecessary waste of time.

Meanwhile, Korean Patent No. 10-1823832 (Patent Document 1) discloses a “freelance client matching platform providing system”, and the freelance client matching platform providing system according thereto includes a membership registration module including a freelancer signup portion that receives freelancer information from a freelancer and a client signup portion that receives client information from a client, a project input module including a project input unit that receives project information on a project to be performed by the client and a project provision unit that generates a project list including at least one piece of project information and provides the project list to the freelancer, a project matching module including a support application unit that generates support application information by receiving information on whether any one of pieces of project information in the project list from the freelancer and a matching processing unit that provides the freelancer with information on a freelancer whose application request information is input to the client and selects one and designates the selected one as a selection target, a result evaluation module including a result input unit that receives a project result from the selection target and a result evaluation unit that receives information on whether the result is approved from the client, and a settlement processing module that receives settlement money for approved and processed results from the client and provides the settlement money to the selection target.

The Patent Document 1 described above has an advantage in that a freelancer may perform optimized project brokerage by analyzing a freelancers' past project participation tendency and allowing the freelancer to participate in a project that suits his/her tendency, an important keyword may be easily identified by calculating keywords from a conversation between the freelancer and a client during work-related communication and displaying the keywords in a work window, and a project result may be produced based thereon, but there is an issue in that a main technical core of a system assigns a freelancer suitable for performing the project by receiving project information on a project to be performed from the client and based thereon and the final result is calculated by the freelancer, various types of general works (for example, simple tasks that may be performed in 2-3 hours, document work, market (data) research, design, video editing, marketing, interpretation/translation, and so on), not a project basis, may be requested, and may be performed by a person performing the work.

(Prior patent document 1) Korean Patent No. 10-1823832 (published on Jan. 31, 2018).

### SUMMARY

The present disclosure is to comprehensively solve the above issues, and provides a non-face-to-face online business matching system and method that, when a user (client) requests a business, may divide the business (task) into detailed businesses in a system, analyze mutual requirements between the client and a business performer, assign a person who may perform the business (a business performer), and derive a result, thereby saving time and cost from a user's (client's) viewpoint, and may obtain profits while demonstrating one's ability without time or space constraints from a business performer's viewpoint.

A non-face-to-face online business matching system according to the present disclosure includes a user (client) terminal connected to a service providing server through the Internet and configured to request a business, a service providing server configured to divide a business requested by the user (client) terminal into detailed businesses (tasks), analyze mutual requirements between a business requester and a business performer, selects a person (the business performer) capable of performing a related business, and assign the businesses, and a business performer terminal configured to receive the businesses assigned by the service providing server through the Internet, perform the businesses, derive a result, and provide the result to the user (client) terminal through the Internet.

Here, when the service providing server divides the business requested by the user (client) terminal into detailed businesses (tasks), the businesses may be classified into a major category, a medium category, and a minor category according to properties or fields of the businesses.

Also, the major category may include “document work”, “market (data) research”, “design”, “video”, “marketing”, “interpretation and translation”, and “others”.

Also, the medium category of the “document work” in the major category may include document style editing, data input, thesis proofreading, format conversion, simple input, and checking of spelling and typos.

Also, the medium category of the “market (data) research” in the major category may include thesis search, Internet data search, telephone survey, and survey agency.

Also, the medium category of “design” in the major category may include logo/branding, detail/event page, print/promotional material, infographic, web/mobile design, package design, caricature, webtoon/character/emoticon, blog/SNS/thumbnail, design modification and file conversion, and three-dimensional (3D) modeling.

Also, the medium category of “video” in the major category may include video editing, video correction, video subtitle, video planning, and video production.

Also, the medium category of “marketing” of the major category may include SNS setting and management, search keyword advertising, content creation, and web page creation (no coding).

Also, the medium category of “interpretation and translation” in the major category may include interpretation, rough translation, full-text translation, proofreading, and correction of translated sentences.

Also, the medium category of “others” in the major category may include purchase agency, purchase information organization, administrative assistance, simple accounting (receipt organization), reservation management, and customer member management.

Also, when the service providing server analyzes the mutual requirements between the business requester and the business performer and selects the people (business performers) capable of performing the related work and assigns the businesses, the businesses of the business performer may be classified into a major category, a medium category, and a minor category and the businesses are assigned.

Also, the major category may include “program competency”, “professional competency”, and “personal competency”.

Also, the medium category for the “program competency” in the major category may include document, design, video, website (no-coding), three-dimension, statistics, and search optimization, and the medium category of the “professional competency” in the major category includes design, planning capability, writing skills, typing, SNS, data research, and language competency, and the medium category of the “personal competency” includes communication, interaction, humanistic thinking, logic, problem solving, comprehension, information utilization, time concept, work speed, objectivity, critical thinking, sincerity, empathy, collaboration ability, receptivity, and creativity.

Also, the minor category for the document in the medium category for the “program competency” in the major category may include Hancom Office, Microsoft Word, Microsoft Excel, Microsoft Powerpoint, Google Word, Google Excel, and Google Powerpoint.

Also, the minor category for the design in the medium category for the “program competency” in the major category may include Photoshop, Illustrator, InDesign, Precanvas, Canva, Mangoboard, Figma, Sketch, Zeppelin, XD, and Snaps.

Also, the minor category for the video in the medium category for the “program competency” in the major category may include Adobe After Effects, Final Cut Pro, Adobe Premiere Pro, and a smartphone video editing program (for example, Movavi).

Also, the minor category for the three-dimension in the medium category for the “program competency” in the major category may include 3ds Max, Maya, Autocad, Zbrush, Blender, Rhino, and C4D.

Also, the minor category for the design in the medium category for the “professional competency” in the major category may include editorial design, package design, proposal (report) design, web design, app design, UI design, content design, product design, PPT design, character design, icon design, animation design, video design, typography, and figma.

Also, the minor categories for the planning capability in the medium category for the “professional competency” in the major category may include content planning, card news planning, UX design, video planning, and business planning.

Also, the minor category for the writing skill in the medium category for the “professional competency” in the major category may include report, business plan, thesis, press data, content manuscript, storytelling, and blog/post.

Also, the minor category for the typing in the medium category for the “professional competency” in the major category may include Korean typing (speed), Korean typing (accuracy), equation, English typing (speed), and English typing (accuracy).

Also, the minor category for the SNS in the medium category for the “professional competency” in the major category may include Facebook, Instagram, Naver Blog, YouTube, and TikTok.

Also, the minor category for the data research in the medium category for the “professional competency” in the major category may include overseas sites, domestic sites, Internet information search, theses, and reports.

Also, the minor category for the language competency in the medium category for the “professional competency” in the major category may include Korean, English, Chinese, Japanese, French, Spanish, and Vietnamese.

Also, the service providing server may store a requirement analysis algorithm (program) for analyzing the mutual requirements between the business requester and the business performer.

Also, a non-face-to-face online business matching method according to the present disclosure includes requesting a business by connecting a user (client) terminal to a service providing server through the Internet, dividing, the service providing server, the business requested by the user (client) terminal into detailed businesses (tasks), analyzing mutual requirements between a business requester and a business performer, selecting a person (the business performer) capable of performing a related business, and assigning the businesses by the service providing server, receiving the assigned businesses from the service providing server through the Internet, performing the businesses, and deriving a result by the business performer terminal, and providing the result derived by the business performer terminal to the user (client) terminal through the Internet.

Here, in b), when the service providing server divides the business requested by the user (client) terminal into detailed businesses (tasks), the businesses may be classified into a major category, a medium category, and a minor category according to properties or fields of the businesses.

Also, the major category may include “document work”, “market (data) research”, “design”, “video”, “marketing”, “interpretation and translation”, and “others”.

Also, the medium category of the “document work” in the major category may include document style editing, data input, thesis proofreading, format conversion, simple input, and checking of spelling and typos.

Also, the medium category of the “market (data) research” in the major category may include thesis search, Internet data search, telephone survey, and survey agency.

Also, the medium category of “design” in the major category may include logo/branding, detail/event page, print/promotional material, infographic, web/mobile design, package design, caricature, webtoon/character/emoticon, blog/SNS/thumbnail, design modification and file conversion, and three-dimensional (3D) modeling.

Also, the medium category of “video” in the major category may include video editing, video correction, video subtitle, video planning, and video production.

Also, the medium category of “marketing” of the major category may include SNS setting and management, search keyword advertising, content creation, and web page creation (no coding).

Also, the medium category of “interpretation and translation” in the major category may include interpretation, rough translation, full-text translation, proofreading, and correction of translated sentences.

Also, the medium category of “others” in the major category may include purchase agency, purchase information organization, administrative assistance, simple accounting (receipt organization), reservation management, and customer member management.

Also, in c), when the service providing server analyzes the mutual requirements between the business requester and the business performer and selects the people (business performers) capable of performing the related work and assigns the businesses, the businesses of the business performer may be classified into a major category, a medium category, and a minor category and the businesses are assigned.

Also, the major category may include “program competency”, “professional competency”, and “personal competency”.

Also, the medium category for the “program competency” in the major category may include document, design, video, website (no-coding), three-dimension, statistics, and search optimization, and the medium category of the “professional competency” in the major category includes design, planning capability, writing skills, typing, SNS, data research, and language competency, and the medium category of the “personal competency” includes communication, interaction, humanistic thinking, logic, problem solving, comprehension, information utilization, time concept, work speed, objectivity, critical thinking, sincerity, empathy, collaboration ability, receptivity, and creativity.

Also, the minor category for the document in the medium category for the “program competency” in the major category may include Hancom Office, Microsoft Word, Microsoft Excel, Microsoft Powerpoint, Google Word, Google Excel, and Google Powerpoint.

Also, the minor category for the design in the medium category for the “program competency” in the major category may include Photoshop, Illustrator, InDesign, Precanvas, Canva, Mangoboard, Figma, Sketch, Zeppelin, XD, and Snaps.

Also, the minor category for the video in the medium category for the “program competency” in the major category may include Adobe After Effects, Final Cut Pro, Adobe Premiere Pro, and a smartphone video editing program (for example, Movavi).

Also, the minor category for the three-dimension in the medium category for the “program competency” in the major category may include 3ds Max, Maya, Autocad, Zbrush, Blender, Rhino, and C4D.

Also, the minor category for the design in the medium category for the “professional competency” in the major category may include editorial design, package design, proposal (report) design, web design, app design, UI design, content design, product design, PPT design, character design, icon design, animation design, video design, typography, and figma.

Also, the minor categories for the planning capability in the medium category for the “professional competency” in the major category may include content planning, card news planning, UX design, video planning, and business planning.

Also, the minor category for the writing skill in the medium category for the “professional competency” in the major category may include report, business plan, thesis, press data, content manuscript, storytelling, and blog/post.

Also, the minor category for the typing in the medium category for the “professional competency” in the major category may include Korean typing (speed), Korean typing (accuracy), equation, English typing (speed), and English typing (accuracy).

Also, the minor category for the SNS in the medium category for the “professional competency” in the major category may include Facebook, Instagram, Naver Blog, YouTube, and TikTok.

Also, the minor category for the data research in the medium category for the “professional competency” in the major category may include overseas site, domestic site, Internet information search, thesis, and report.

Also, the minor category for the language competency in the medium category for the “professional competency” in the major category may include Korean, English, Chinese, Japanese, French, Spanish, and Vietnamese.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating the entire configuration of a non-face-to-face online business matching system according to the present disclosure;

FIG. 2 is a flowchart illustrating a performance process of a non-face-to-face online business matching method according to the present disclosure;

FIGS. 3A and 3B are diagrams illustrating that a service providing server assigns businesses by classifying businesses requested from a client for each of detailed businesses and selects a business performer;

FIG. 4 is a diagram illustrating the well-known recruitment/job seeking method and a recruitment/job seeking method, to which a non-face-to-face online business matching method is applied, according to the present disclosure;

FIG. 5 is a diagram illustrating a process of deriving a result by dividing business into detailed businesses according to a non-face-to-face online business matching system and method according to the present disclosure;

FIG. 6 is a diagram illustrating a process of a quality control system (QCS) applied to a non-face-to-face online business matching system and method, according to the present disclosure; and

FIG. 7 is a diagram illustrating an operation and a resultant effect of a non-face-to-face online business matching system and method according to the present disclosure.

### DETAILED DESCRIPTION

Terms or words used in the present specification and claims should not be construed as limited to their ordinary or dictionary meanings and should be interpreted with meaning and concept consistent with the technical idea of the present disclosure based on the principle that the inventor may appropriately define the concepts of the terms in order to describe his or her invention in the best way.

Throughout the specification, when a portion “includes” a certain component, this means that the portion does not exclude other components but may further include other components, unless specifically stated to the contrary. In addition, terms, such as a “ . . . portion”, a “ . . . unit”, a “module”, and a “device” used in the specification refer to a unit that processes at least one function or operation, which may be implemented by hardware, software, or a combination of hardware and software.

Hereinafter, embodiments of the present disclosure are described in detail with reference to the attached drawings.

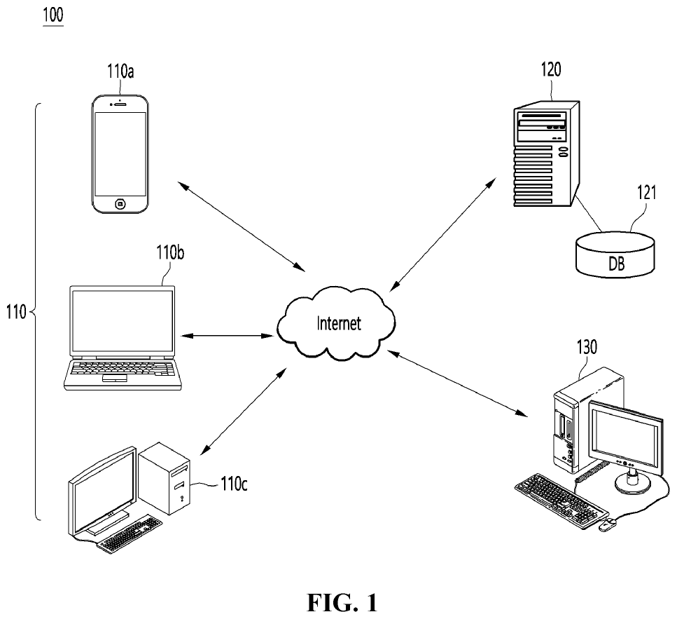

FIG. 1 is a diagram illustrating the entire configuration of a non-face-to-face online business matching system according to an embodiment of the present disclosure.

Referring to FIG. 1, a non-face-to-face online business matching system 100 according to the present disclosure may include a user (client) terminal 110, a service providing server 120, and a business performer terminal 130.

The user (client) terminal 110 is connected to the service providing server 120 through the Internet to request a certain business (for example, generating a thumbnail, searching Internet data, and so on). In this case, the user (client) terminal 110 may include a smartphone 110a, a laptop computer 110b, a desktop computer 110c, and so on. That is, a user (client) first accesses a website of a service providing company in which the service providing server 120 is installed by using his/her terminal (for example, the smartphone 110a) and then enter a work assignment window of a homepage to input a requested business, date and time, total working hours, and so on.

The service providing server 120 divides a businesses requested through the user (client) terminal 110 into detailed businesses (tasks) based on detailed category table data for various businesses stored in the database (DB) 121, analyzes mutual requirements between a business requester and a business performer, selects a person (business performer) who may perform the business, and assigns the business to the person. The service providing server 120 may store a requirement analysis algorithm (program) for analyzing the mutual requirements between the business requester and the business performer. In addition, the database (DB) 121 may store basic individual information on users (clients) who request businesses, basic individual information on business performers who perform businesses, and information or data on business experience and a specialized technical field. Here, a service providing company, which operates the service providing server 120, may operate an hourly coupon system in relation to cost processing (payment) according to use of a service by a user (client). For example, the service providing company issues coupons of 100,000 won, 150,000 won, 200,000 won, 400,000 won, and so on per hour depending on properties (difficulty and so on) of the business, and a service user (a business requester) purchases the coupons to use the service.

The business performer terminal 130 receives the assigned business from the service providing server 120 through the Internet, performs the business, derives a result, and transmits the derived result to the user (client) terminal 110 through the Internet. Like the user (client) terminal 110, the business performer terminal 130 may include a smartphone, a laptop computer, a desktop computer, and so on. Here, when providing the result derived from a business performer to a business requester, and when it is difficult or impossible to provide the result online due to properties thereof, the result may also be provided offline.

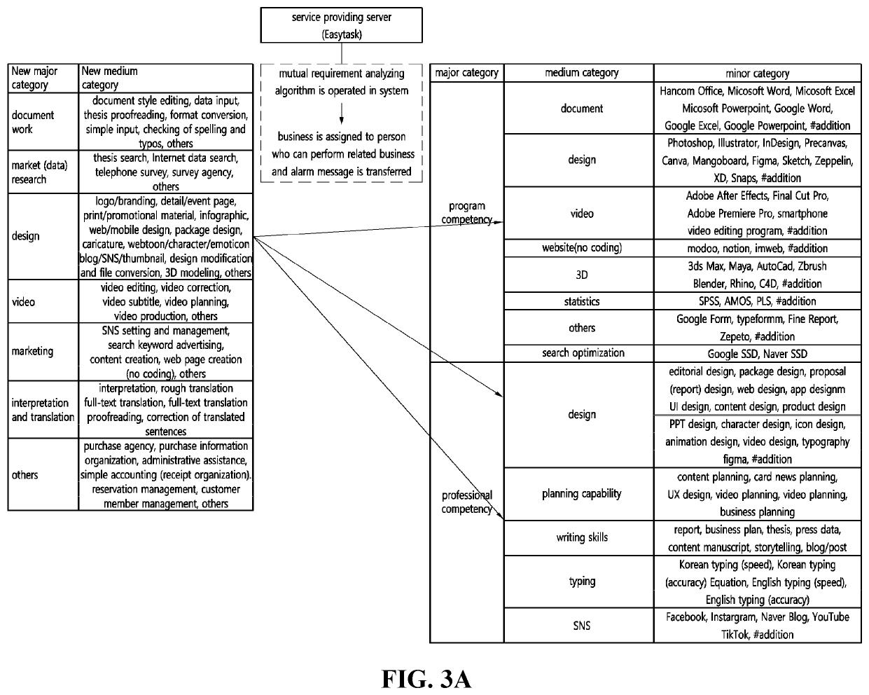

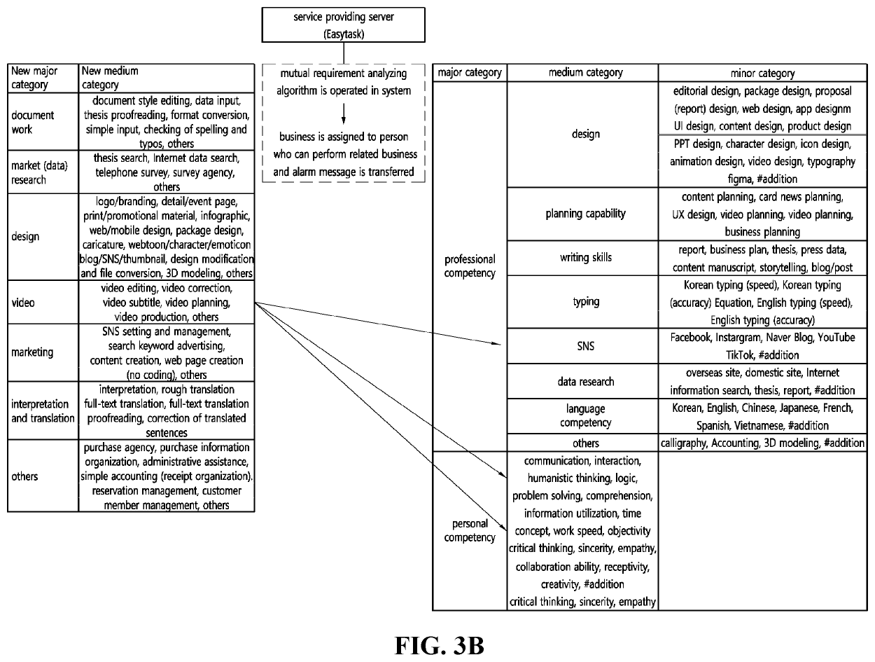

According to the non-face-to-face online business matching system 100 of the present disclosure having the configuration described above, when the service providing server 120 divides the business requested through the user (client) terminal 110 into detailed businesses (tasks), the business may be divided into a major category, a medium category, and a minor category depending on properties or fields of the business as illustrated in FIGS. 3A and 3B.

In this case, the major category may include a “document work”, a “market (data) research”, “design”, “video”, “marketing”, “interpretation and translation”, and “others”.

In this case, the medium category of the “document work” in the major category may include document style editing, data input, thesis proofreading, format conversion, simple input, and checking of spelling and typos.

In this case, the medium category of the “market (data) research” in the major category may include thesis search, Internet data search, telephone survey, and survey agency.

In this case, the medium category of “design” in the major category may include logo/branding, detail/event page, print/promotional material, infographic, web/mobile design, package design, caricature, webtoon/character/emoticon, blog/SNS/thumbnail, design modification and file conversion, and three-dimensional (3D) modeling.

In this case, the medium category of “video” in the major category may include video editing, video correction, video subtitle, video planning, and video production.

In this case, the medium category of “marketing” of the major category may include SNS setting and management, search keyword advertising, content creation, and web page creation (no coding).

In this case, the medium category of “interpretation and translation” in the major category may include interpretation, rough translation, full-text translation, proofreading, and correction of translated sentences.

In this case, the medium category of “others” in the major category may include purchase agency, purchase information organization, administrative assistance, simple accounting (receipt organization), reservation management, and customer member management.

Also, when the service providing server 120 analyzes the mutual requirements between the business requester and the business performer and selects a person (business performer) who may perform the related business and assigns the business thereto, the service providing server 120 may divide a business of the business performer into a major category, a medium category, and a minor category and assign the business.

In this case, the major category may include “program competency”, “professional competency”, and “personal competency”.

In this case, the medium category for the “program competency” in the major category may include document, design, video, website (no-coding), 3D, statistics, and search optimization, and the medium category of the “professional competency” in the major category may include design, planning capability, writing skills, typing, SNS, data research, and language competency, and the medium category of the “personal competency” may include communication, interaction, humanistic thinking, logic, problem solving, comprehension, information utilization, time concept, work speed, objectivity, critical thinking, sincerity, empathy, collaboration ability, receptivity, and creativity.

In this case, the minor category for the document in the medium category for the “program competency” in the major category may include Hancom Office, Microsoft Word, Microsoft Excel, Microsoft Powerpoint, Google Word, Google Excel, and Google Powerpoint.

In this case, the minor category for the design in the medium category for the “program competency” in the major category may also include Photoshop, Illustrator, InDesign, Precanvas, Canva, Mangoboard, Figma, Sketch, Zeppelin, XD, and Snaps.

In this case, the minor category for the video in the medium category for the “program competency” in the major category may also include Adobe After Effects, Final Cut Pro, Adobe Premiere Pro, and a smartphone video editing program (for example, Movavi).

In this case, the minor category for the 3D in the medium category for the “program competency” in the major category may also include 3ds Max, Maya, Autocad, Zbrush, Blender, Rhino, and C4D.

In this case, the minor category for the design in the medium category for the “professional competency” in the major category may also include editorial design, package design, proposal (report) design, web design, app design, UI design, content design, product design, PPT design, character design, icon design, animation design, video design, typography, and figma.

In this case, the minor categories for the planning capability in the medium category for the “professional competency” in the major category may also include content planning, card news planning, UX design, video planning, and business planning.

In this case, the minor category for the writing skill in the medium category for the “professional competency” in the major category may include report, business plan, thesis, press data, content manuscript, storytelling, and blog/post.

In this case, the minor category for the typing in the medium category for the “professional competency” in the major category may also include Korean typing (speed), Korean typing (accuracy), equation, English typing (speed), and English typing (accuracy).

In this case, the minor category for the SNS in the medium category for the “professional competency” in the major category may also include Facebook, Instagram, Naver Blog, YouTube, and TikTok.

In this case, the minor category for the data research in the medium category for the “professional competency” in the major category may also include overseas sites, domestic sites, Internet information search, theses, and reports.

In this case, the minor category for the language competency in the medium category for the “professional competency” in the major category may also include Korean, English, Chinese, Japanese, French, Spanish, and Vietnamese.

Here, details of each item of the major category, the medium category, and the minor category described above are not limited to the previously given descriptions and may be changed to various descriptions depending on cases.

In FIGS. 3A and 3B, (a) represents a user (client) area for requesting the business, and (b) represents a business performer area for performing the business.

Then, hereinafter, a non-face-to-face online business matching method will be described based on a non-face-to-face online business matching system having the above configuration, according to the present disclosure.

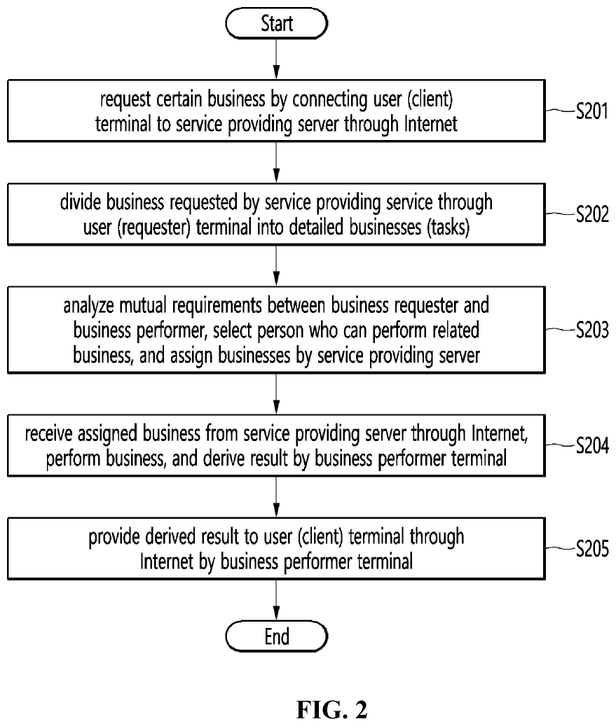

FIG. 2 is a flowchart illustrating a process of performing a non-face-to-face online business matching method according to an embodiment of the present disclosure.

Referring to FIG. 2, the non-face-to-face online business matching method according to the present disclosure is based on the non-face-to-face online business matching system 100 including the user (client) terminal 110, the service providing server 120, and the business performer terminal 130 described above, and first, the user (client) terminal 110 is connected to the service providing server 120 through the Internet to request any business (for example, web/mobile design creation, video editing, or so on) (S201). That is, a user (client) first accesses a website (homepage) of a service providing company, in which the service providing server 120 is installed, by using his/her terminal (for example, a desktop computer 110c), and then enters a work assignment (business request) window of the homepage and inputs basic information on a requester, a requested business, requested date and time, a total business time, and so on.

In this way, when a certain business is requested by the user (client) terminal 110, the service providing server 120 divides the business requested by the user (client) terminal 110 into detailed businesses (tasks) (S202). That is, the service providing server 120 divides the business requested by the user (client) terminal 110 into detailed businesses (tasks) based on detailed category table data for various businesses stored in the database (DB) 121.

Then, the service providing server 120 analyzes mutual requirements between a business requester and a business performer by using a built-in requirement analysis algorithm (program), and then selects a person (business performer) who may perform the related business and assigns the business to the person (S203).

Then, the business performer terminal 130 receives the assigned business from the service providing server 120 through the Internet, performs the business, and derives a result (S204).

Then, finally, the business performer terminal 130 provides the derived result to the user (client) terminal 110 through the Internet (S205). Here, as described above, when providing the derived result from the business performer to the business requester, and when it is difficult or impossible to provide the result online due to their properties (characteristics), the result may be provided offline.

In the process described above, when the service providing server 120 divides a business requested by the user (client) terminal 110 into detailed businesses (tasks) in S202, the businesses may be classified into a major category, a medium category, and a minor category depending on properties or fields as illustrated in FIGS. 3A and 3B. In FIGS. 3A and 3B, (a) represents a user (client) area for requesting the business, and (b) represents a business performer area for performing the business.

In this case, the major category may include a “document work”, a “market (data) research”, “design”, “video”, “marketing”, “interpretation and translation”, and “others”.

In this case, the medium category of the “document work” in the major category may include document style editing, data input, thesis proofreading, format conversion, simple input, and checking of spelling and typos.

In this case, the medium category of the “market (data) research” in the major category may include thesis search, Internet data search, telephone survey, and survey agency.

In this case, the medium category of “design” in the major category may include logo/branding, detail/event page, print/promotional material, infographic, web/mobile design, package design, caricature, webtoon/character/emoticon, blog/SNS/thumbnail, design modification and file conversion, and three-dimensional (3D) modeling.

In this case, the medium category of “video” in the major category may include video editing, video correction, video subtitle, video planning, and video production.

In this case, the medium category of “marketing” of the major category may include SNS setting and management, search keyword advertising, content creation, and web page creation (no coding).

In this case, the medium category of “interpretation and translation” in the major category may include interpretation, rough translation, full-text translation, proofreading, and correction of translated sentences.

In this case, the medium category of “Others” in the major category may include purchase agency, purchase information organization, administrative assistance, simple accounting (receipt organization), reservation management, and customer member management.

Also, in step S203, when the service providing server 120 analyzes the mutual requirements between the business requester and the business performer and selects a person (business performer) who may perform the related business and assigns the business thereto, the service providing server 120 may divide a business of the business performer into a major category, a medium category, and a minor category and assign the business as illustrated in (b) of FIGS. 3A and 3B.

In this case, the major category may include “program competency”, “professional competency”, and “personal competency”.

In this case, the medium category for the “program competency” in the major category may include document, design, video, website (no-coding), 3D, statistics, and search optimization, and the medium category for the “professional competency” in the major category may include design, planning capability, writing skills, typing, SNS, data research, and language competency, and the medium category of the “personal competency” may include communication, interaction, humanistic thinking, logic, problem solving, comprehension, information utilization, time concept, work speed, objectivity, critical thinking, sincerity, empathy, collaboration ability, receptivity, and creativity.

In this case, the minor category for the document in the medium category for the “program competency” in the major category may include Hancom Office, Microsoft Word, Microsoft Excel, Microsoft Powerpoint, Google Word, Google Excel, and Google Powerpoint.

In this case, the minor category for the design in the medium category for the “program competency” in the major category may also include Photoshop, Illustrator, InDesign, Precanvas, Canva, Mangoboard, Figma, Sketch, Zeppelin, XD, and Snaps.

In this case, the minor category for the video in the medium category for the “program competency” in the major category may also include Adobe After Effects, Final Cut Pro, Adobe Premiere Pro, and a smartphone video editing program (for example, Movavi).

In this case, the minor category for the 3D in the medium category for the “program competency” in the major category may also include 3ds Max, Maya, Autocad, Zbrush, Blender, Rhino, and C4D.

In this case, the minor category for the design in the medium category for the “professional competency” in the major category may also include editorial design, package design, proposal (report) design, web design, app design, UI design, content design, product design, PPT design, character design, icon design, animation design, video design, typography, and figma.

In this case, the minor categories for the planning capability in the medium category for the “professional competency” in the major category may also include content planning, card news planning, UX design, video planning, and business planning.

In this case, the minor category for the writing skill in the medium category for the “professional competency” in the major category may include report, business plan, thesis, press data, content manuscript, storytelling, and blog/post.

In this case, the minor category for the typing in the medium category for the “professional competency” in the major category may also include Korean typing (speed), Korean typing (accuracy), equation, English typing (speed), and English typing (accuracy).

In this case, the minor category for the SNS in the medium category for the “professional competency” in the major category may also include Facebook, Instagram, Naver Blog, YouTube, and TikTok.

In this case, the minor category for the data research in the medium category for the “professional competency” in the major category may also include overseas sites, domestic sites, Internet information search, theses, and reports.

In this case, the minor category for the language competency in the medium category for the “professional competency” in the major category may also include Korean, English, Chinese, Japanese, French, Spanish, and Vietnamese.

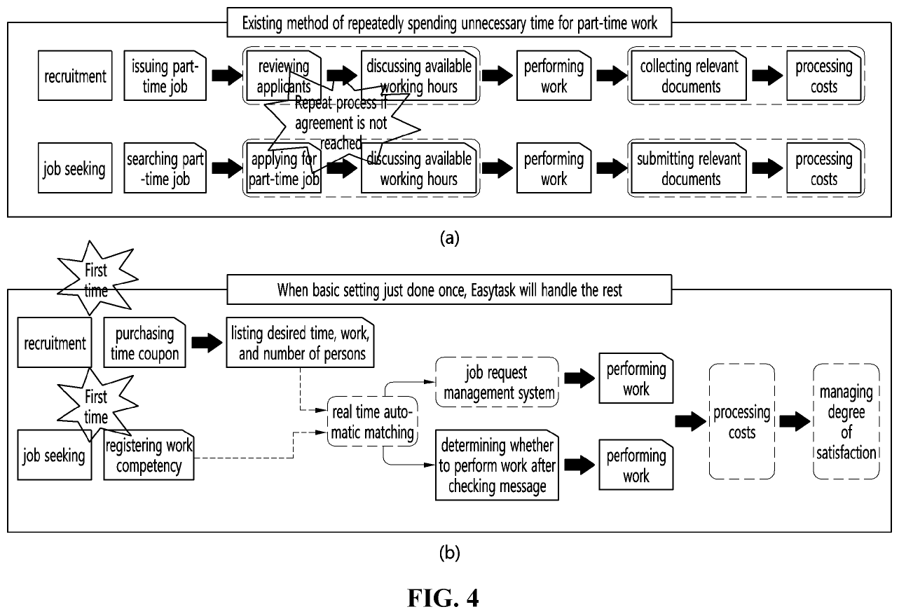

Meanwhile, FIG. 4 is a diagram illustrating the well-known recruitment/job seeking method and a recruitment/job seeking method, to which a non-face-to-face online business matching method is applied, according to the present disclosure.

Referring to FIG. 4, (a) illustrates a conventional recruitment/job search method, and (b) illustrates a job recruitment/job search method to which the non-face-to-face online business matching system according to the present disclosure is applied.

As illustrated in (a) of FIG. 4, according to the well-known recruitment/job seeking method, \textcircled{1} a recruiter issues a part-time job (side job) announcement, \textcircled{2} a job seeker searches and applies for the part-time job announcement issued by the recruiter, and \textcircled{3} the recruiter reviews applicants and discusses available working hours and so on with a job seeker (part-time job applicant). In this case, when an agreement is not made between the recruiter and the job seeker (part-time job applicant), the above processes \textcircled{1} to \textcircled{3} are repeated.

Meanwhile, when an agreement is made between the recruiter and the job seeker (part-time job applicant), the job seeker (part-time job applicant) submits relevant documents, the recruiter collects the relevant documents, and then costs are processed between the recruiter and the job seeker.

As described above, according to the well-known recruitment/job-seeking method, unnecessary time has to be repeatedly spent on a part-time job.

As illustrated in (b) of FIG. 4, according to a recruitment/job seeking method, to which a non-face-to-face online business matching system, according to the present disclosure is applied, a recruiter (job requester) accesses a system of the present disclosure, purchases a time coupon (a type of coupon that allows the recruiter to request hourly work), lists the desired time, work, and number of persons, and the job seeker (job performer) accesses the system and registers his/her work competency (a main work area, career, and so on) Then, a server of the system (the service providing server 120) automatically matches the information input by the recruiter (job requester) (that is, job request items) and the information registered by the job seeker (job performer) in real time and connects the recruiter (job requester) to the job seeker (job requester). Then, the server (the service providing server 120) manages the requested job through the job request management system, and the job seeker (job performer) determines whether to perform the work and then perform the work.

hereafter, the server (the service providing server 120) processes costs for the job seeker (job performer) and manages degree of satisfaction with the recruiter (job requester).

As described above, in the recruitment/job seeking method, to which the non-face-to-face online business matching system is applied, according to the present disclosure, once the recruiter (job requester) and job seeker (job performer) sets a basic item the first time, the other parts are managed and processed by the system (a system operator), the recruiter (job requester) may perform the business efficiently or use time more effectively without wasting unnecessary time on both sides, and the job seeker (job performer) may perform business at the time he/she wants without time and space constraints and may expand his/her self-development competency.

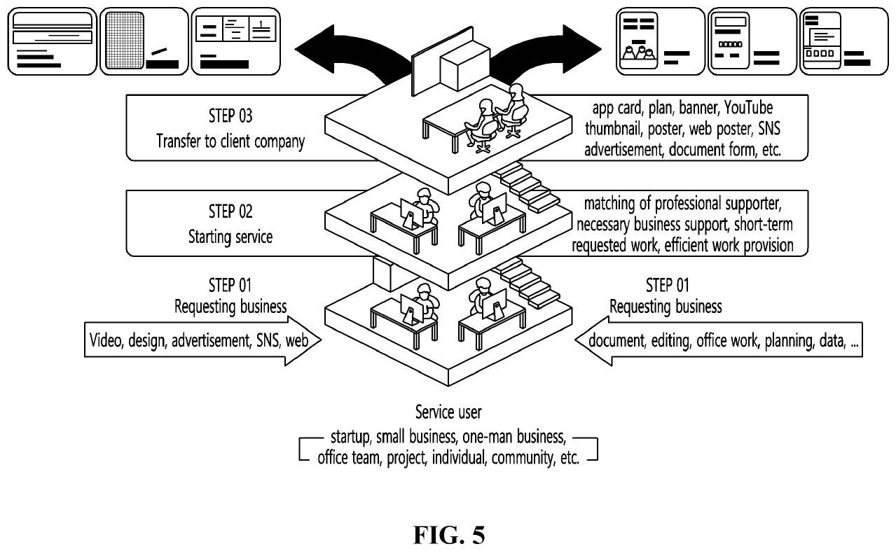

FIG. 5 is a diagram illustrating a process of deriving a result by dividing business into detailed businesses according to a non-face-to-face online business matching system and method according to the present disclosure.

Referring to FIG. 5, in the non-face-to-face online business matching system and method according to the present disclosure, when a business is requested by a user (service user), the business is divided into detailed businesses, not project, and a professional supporter (business performer) is assigned thereto, and a result is derived as illustrated in FIG. 5. There is an effect that the business is performed efficiently in a short period of time.

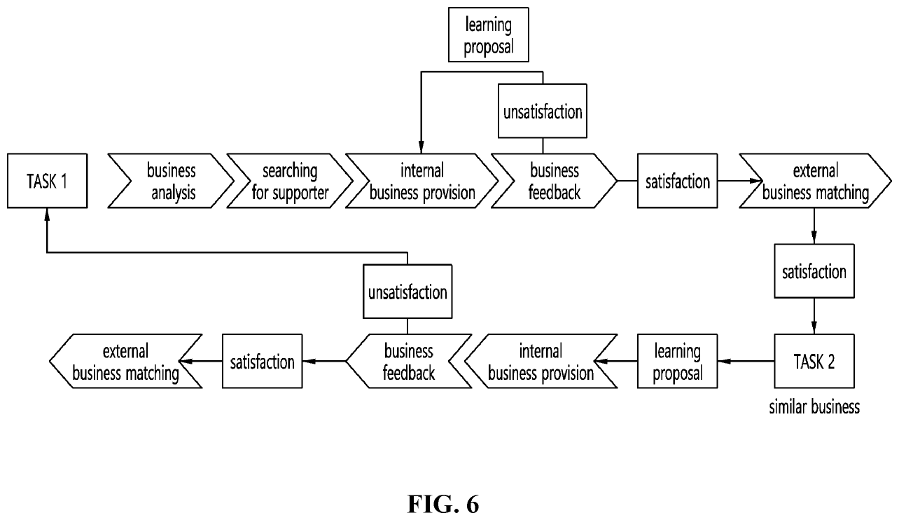

FIG. 6 is a diagram illustrating a process of a quality control system (QCS) applied to a non-face-to-face online business matching system and method, according to the present disclosure.

Referring to FIG. 6, a QCS is preferably applied to the non-face-to-face online business matching system and method according to the present disclosure. That is, first, a certain first business TASK1 is analyzed, and a supporter (business performer) most suitable for performing the business is searched. Thereafter, an internal business is provided, and feedback is received on a business result. As a result of the feedback, when the business result is unsatisfactory, the internal business is provided again along with learning suggestion. In addition, as a result of the feedback, when the business result is satisfactory, an external business is assigned. When the business result is satisfactory, a learning proposal is made for similar business TASK2 and the internal business is provided. In addition, feedback on the business result is received. As a result of the feedback, when the business result is unsatisfactory, the processing returns to the first step that is the first business TASK1. In addition, when the business result on the similar business TASK2 is satisfactory, the external business is assigned. In this way, according to the present disclosure, by introducing and operating the QCS, a high quality business result may be provided to service users, and as a result, a service user's satisfaction on the service may be further increased.

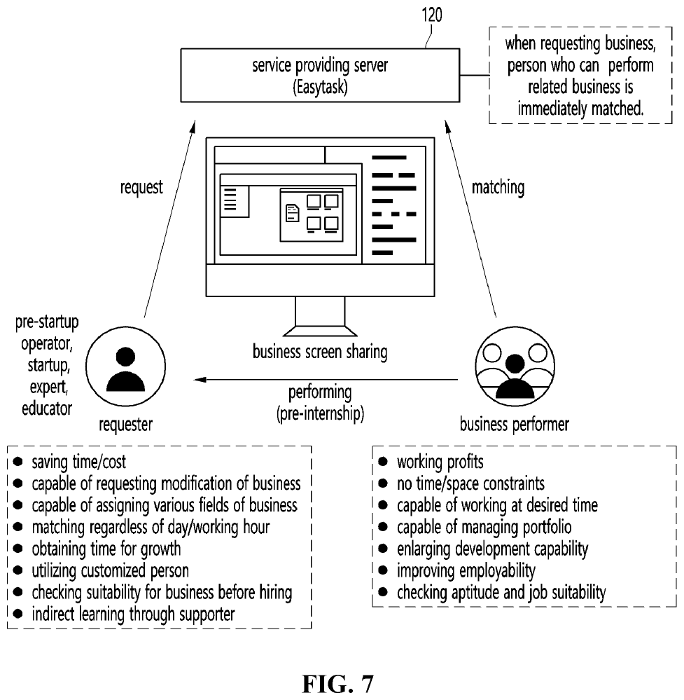

FIG. 7 is a diagram illustrating an operation and a resultant effect of a non-face-to-face online business matching system and method according to the present disclosure.

Referring to FIG. 7, when a requester (for example, a pre-startup operator, startup, expert, educator, or so on) requests a business, the service providing server 120 of a service providing company (for example, Easytask) immediately assigns a person who may perform the related business, and the person performer performs the assigned business. In this case, at least a business screen may be shared between a business requester and a business performer. That is, online communication may be performed between the business requester and the business performer while the business is in progress.

By performing the series of businesses described above, a requester may save time and cost, modification request may be made during business, and businesses in various fields may be assigned. Also, matching may be made regardless of day of the week and working hours, time for the requester's own growth may be obtained, and customized person may be utilized. In addition, suitability for business may be checked before hiring, and indirect learning may be made through a business performer (supporter).

In addition, a business performer may perform the business without time and space constraints and create profits according thereto. Also, a requester may work any time when he/she wants and manage portfolio. In addition, there are advantages of being able to expand self-development capabilities, increase employability, and check aptitude and job suitability in advance.

As described above, in a non-face-to-face online business matching system and method according to the present disclosure, when a user (client) requests a certain business, the business is divided into detailed businesses (tasks) in the system, mutual requirements are analyzed between the requester and a business performer, a person (business performer) who may perform the related business, and derives a result, and thus, time and cost may be saved from the perspective of the user (client), and profits may be created and one's ability may be demonstrated without time or space constraints from the perspective of the business performer.

In addition, there is an advantage in that women may demonstrate and continuously develop specific skills or functions without interruption in career due to childbirth or childcare and may contribute to the creation of goods and the revitalization of economy by providing consulting on corporate management or startup by using knowledge and accumulated experience in specialized fields.

As described above, the present disclosure is described in detail through preferred embodiments and is not limited thereto, and it is obvious to those skilled in the art that various changes and applications may be made without departing from the technical idea of the present disclosure. Therefore, the true scope of protection of the present disclosure should be interpreted in accordance with the following claims, and all technical ideas within the equivalent scope should be interpreted as being included in the scope of rights of the present disclosure.

### MODE FOR IMPLEMENTING THE INVENTION

The mode for implementing the invention is the same as the best mode for implementing the invention described above.

### INDUSTRIAL APPLICABILITY

The present disclosure may be used in the non-face-to-face online business matching industry, and accordingly, the present disclosure has industrial applicability.

What is claimed is:

1. A non-face-to-face online business matching system comprising:
a client terminal connected to a service providing server through the Internet and configured to request a business;
the service providing server configured to divide a business requested by the client terminal into detailed businesses, analyze mutual requirements between a business requester and a business performer, select in real time a person (the business performer) capable of performing a related business, and assign the businesses to the selected person; and
a business performer terminal configured to receive the businesses assigned by the service providing server through the Internet, perform the businesses, derive a result, and provide the result to the client terminal through the Internet,
wherein, when dividing the business requested by the client terminal into the detailed businesses, the service providing server divides the requested business into a major category, a medium category, and a minor category according to properties or fields of the detailed businesses,
the major category is a business field including “document work”, “market research”, “design”, “video”, “marketing”, “interpretation and translation”, and “others”, and the medium category is a performance business for the business field,
when analyzing the mutual requirements between the client and the business performer and selecting the person (the business performer) capable of performing the related work and assigning the businesses, the service providing server divides a business of the business performer into the major category, the medium category, and the minor category to assign the business, the major category is competency of the business performer, the medium category is a business field of the business performer according to the competency of the business performer, and the minor category is a program used by the business performer when performing the business,
the service providing server analyzes the detailed businesses of the business requested by the user terminal, the competency of the business performer, the business field, and the used program, and matches the business performer terminal performing the business by using the used program corresponding to the requested business with the user terminal that requests the business,
the minor category is a program for deriving a business performance result for the business field of the medium category which is divided according to the requirements,
the client terminal provides a total business hour of the business performer based on a time coupon method to the service providing server by purchasing, by the client terminal, he time coupon provided by the service providing server when requesting the business,
a business screen of a terminal of the business performer can be shared in real time with the client terminal when the business performer performs the business,
the business performer is a person to whom a quality control process according to a quality control system (QCS) of the service providing server below is applied, and
the QCS is configured such that the service providing server
analyzes a random task, searches for the business performer optimized for performing the random business, provides a first internal business to the terminal of the searched business performer, and receives a business result,
determines whether the business result of the first internal business is satisfied, and when determined to be satisfied, matches a first external business to the terminal of the searched business performer,
determines whether a business result of the first external business is satisfied, and when determined to be satisfied, provides a second internal business to the terminal of the searched business performer along with a learning proposal for a similar business of the random business preset, and receives a result thereof, and
determines whether a business result of the second internal business is satisfied and, when determined to be satisfied, matches a second external business to the terminal of the searched business performer.

2. The non-face-to-face online business matching system of claim 1, wherein,
when the service providing server divides the business requested by the user (client) terminal into detailed businesses (tasks), the businesses are classified into a major category, a medium category, and a minor category according to properties or fields of the businesses.

3. The non-face-to-face online business matching system of claim 2, wherein the major category includes “document work”, “market (data) research”, “design”, “video”, “marketing”, “interpretation and translation”, and “others”.

4. The non-face-to-face online business matching system of claim 3, wherein
the medium category of the “document work” in the major category includes document style editing, data input, thesis proofreading, format conversion, simple input, and checking of spelling and typos,
the medium category of the “market (data) research” in the major category includes thesis search, Internet data search, telephone survey, and survey agency,
the medium category of “design” in the major category includes logo/branding, detail/event page, print/promotional material, infographic, web/mobile design, package design, caricature, webtoon/character/emoticon, blog/SNS/thumbnail, design modification and file conversion, and three-dimensional (3D) modeling,
the medium category of “video” in the major category includes video editing, video correction, video subtitle, video planning, and video production,
the medium category of “marketing” of the major category includes SNS setting and management, search keyword advertising, content creation, and web page creation (no coding),
the medium category of “interpretation and translation” in the major category includes interpretation, rough translation, full-text translation, proofreading, and correction of translated sentences, and
the medium category of “others” in the major category includes purchase agency, purchase information organization, administrative assistance, simple accounting (receipt organization), reservation management, and customer member management.

5. The non-face-to-face online business matching system of claim 1, wherein, when the service providing server analyzes the mutual requirements between the business requester and the business performer and selects the people (business performers) capable of performing the related work and assigns the businesses, the businesses of the business performer are classified into a major category, a medium category, and a minor category and the businesses are assigned.

6. The non-face-to-face online business matching system of claim 5, wherein the major category includes “program competency”, “professional competency”, and “personal competency”.

7. The non-face-to-face online business matching system of claim 6, wherein
the medium category for the “program competency” in the major category includes document, design, video, website (no-coding), three-dimension, statistics, and search optimization, and the medium category of the “professional competency” in the major category includes design, planning capability, writing skills, typing, SNS, data research, and language competency, and the medium category of the “personal competency” includes communication, interaction, humanistic thinking, logic, problem solving, comprehension, information utilization, time concept, work speed, objectivity, critical thinking, sincerity, empathy, collaboration ability, receptivity, and creativity,
the minor category for the document in the medium category for the “program competency” in the major category includes Hancom Office, Microsoft Word, Microsoft Excel, Microsoft Powerpoint, Google Word, Google Excel, and Google Powerpoint,
the minor category for the design in the medium category for the “program competency” in the major category includes Photoshop, Illustrator, InDesign, Precanvas, Canva, Mangoboard, Figma, Sketch, Zeppelin, XD, and Snaps,
the minor category for the video in the medium category for the “program competency” in the major category includes Adobe After Effects, Final Cut Pro, Adobe Premiere Pro, and a smartphone video editing program (for example, Movavi),
the minor category for the three-dimension in the medium category for the “program competency” in the major category includes 3ds Max, Maya, Autocad, Zbrush, Blender, Rhino, and C4D,
the minor category for the design in the medium category for the “professional competency” in the major category includes editorial design, package design, proposal (report) design, web design, app design, UI design, content design, product design, PPT design, character design, icon design, animation design, video design, typography, and figma,
the minor categories for the planning capability in the medium category for the “professional competency” in the major category includes content planning, card news planning, UX design, video planning, and business planning,
the minor category for the writing skill in the medium category for the “professional competency” in the major category includes report, business plan, thesis, press data, content manuscript, storytelling, and blog/post,
the minor category for the typing in the medium category for the “professional competency” in the major category includes Korean typing (speed), Korean typing (accuracy), equation, English typing (speed), and English typing (accuracy),
the minor category for the SNS in the medium category for the “professional competency” in the major category includes Facebook, Instagram, Naver Blog, YouTube, and TikTok,
the minor category for the data research in the medium category for the “professional competency” in the major category includes overseas sites, domestic sites, Internet information search, theses, and reports, and
the minor category for the language competency in the medium category for the “professional competency” in the major category includes Korean, English, Chinese, Japanese, French, Spanish, and Vietnamese.

8. The non-face-to-face online business matching system of claim 1, wherein the service providing server stores a requirement analysis algorithm (program) for analyzing the mutual requirements between the business requester and the business performer.

9. A non-face-to-face online business matching method comprising:
a) requesting a business by connecting a user (client) terminal to a service providing server through the Internet;
b) dividing, the service providing server, the business requested by the user (client) terminal into detailed businesses (tasks);
c) analyzing mutual requirements between a business requester and a business performer, selecting in real time a person (the business performer) capable of performing a related business, and assigning the businesses by the service providing server;
d) receiving the assigned businesses from the service providing server through the Internet, performing the businesses, and deriving a result by the business performer terminal; and
e) providing the result derived by the business performer terminal to the user (client) terminal through the Internet,
wherein, in b), when dividing the business requested by the client terminal into the detailed businesses, the service providing server divides the requested business into a major category, a medium category, and a minor category according to properties or fields of the detailed businesses,
the major category is a business field including “document work”, “market research”, “design”, “video”, “marketing”, “interpretation and translation”, and “others”, and the medium category is a performance business for the business field,
in step c), when analyzing the mutual requirements between the client and the business performer and selecting the person (the business performer) capable of performing the related work and assigning the businesses, the service providing server divides a business of the business performer into the major category, the medium category, and the minor category, the major category is competency of the business performer, the medium category is a business field of the business performer according to the competency of the business performer, and the minor category is a program used by the business performer when performing the business,
the service providing server is configured to analyze the detailed businesses of the business requested by the user terminal, the competency of the business performer, the business field, and the used program, and match the business performer terminal performing the business by using the used program corresponding to the requested business with the user terminal that requests the business,
the minor category is a program for deriving a business performance result for the business field of the medium category which is divided according to the requirements,
the client terminal provides a total business hour of the business performer based on a time coupon method to the service providing server by purchasing, by the client terminal, he time coupon provided by the service providing server when requesting the business,
a business screen of a terminal of the business performer can be shared in real time with the client terminal when the business performer performs the business,
the business performer is a person to whom a quality control process according to a quality control system (QCS) of the service providing server below is applied, and
the QCS is configured such that the service providing server
analyzes a random task, searches for the business performer optimized for performing the random business, provides a first internal business to the terminal of the searched business performer, and receives a business result,
determines whether the business result of the first internal business is satisfied, and when determined to be satisfied, matches a first external business to the terminal of the searched business performer,
determines whether a business result of the first external business is satisfied, and when determined to be satisfied, provides a second internal business to the terminal of the searched business performer along with a learning proposal for a similar business of the random business preset, and receives a result thereof, and
determines whether a business result of the second internal business is satisfied and, when determined to be satisfied, matches a second external business to the terminal of the searched business performer.

10. The non-face-to-face online business matching system of claim 9, wherein, in b), when the service providing server divides the business requested by the user (client) terminal into detailed businesses (tasks), the businesses are classified into a major category, a medium category, and a minor category according to properties or fields of the businesses.

11. The non-face-to-face online business matching method of claim 10, wherein
the major category includes “document work”, “market (data) research”, “design”, “video”, “marketing”, “interpretation and translation”, and “others”,
the medium category of the “document work” in the major category includes document style editing, data input, thesis proofreading, format conversion, simple input, and checking of spelling and typos,
the medium category of the “market (data) research” in the major category includes thesis search, Internet data search, telephone survey, and survey agency,
the medium category of “design” in the major category includes logo/branding, detail/event page, print/promotional material, infographic, web/mobile design, package design, caricature, webtoon/character/emoticon, blog/SNS/thumbnail, design modification and file conversion, and three-dimensional (3D) modeling,
the medium category of “video” in the major category includes video editing, video correction, video subtitle, video planning, and video production,
the medium category of “marketing” of the major category includes SNS setting and management, search keyword advertising, content creation, and web page creation (no coding),
the medium category of “interpretation and translation” in the major category includes interpretation, rough translation, full-text translation, proofreading, and correction of translated sentences, and
the medium category of “others” in the major category includes purchase agency, purchase information organization, administrative assistance, simple accounting (receipt organization), reservation management, and customer member management.

12. The non-face-to-face online business matching method of claim 9, wherein, in c), when the service providing server analyzes the mutual requirements between the business requester and the business performer and selects the people (business performers) capable of performing the related work and assigns the businesses, the businesses of the business performer are classified into a major category, a medium category, and a minor category and the businesses are assigned.

13. The non-face-to-face online business matching method of claim 12, wherein
the major category includes “program competency”, “professional competency”, and “personal competency”,
the medium category for the “program competency” in the major category includes document, design, video, website (no-coding), three-dimension, statistics, and search optimization, and the medium category of the “professional competency” in the major category includes design, planning capability, writing skills, typing, SNS, data research, and language competency, and the medium category of the “personal competency” includes communication, interaction, humanistic thinking, logic, problem solving, comprehension, information utilization, time concept, work speed, objectivity, critical thinking, sincerity, empathy, collaboration ability, receptivity, and creativity,
the minor category for the document in the medium category for the “program competency” in the major category includes Hancom Office, Microsoft Word, Microsoft Excel, Microsoft Powerpoint, Google Word, Google Excel, and Google Powerpoint,
the minor category for the design in the medium category for the “program competency” in the major category includes Photoshop, Illustrator, InDesign, Precanvas, Canva, Mangoboard, Figma, Sketch, Zeppelin, XD, and Snaps,
the minor category for the video in the medium category for the “program competency” in the major category includes Adobe After Effects, Final Cut Pro, Adobe Premiere Pro, and a smartphone video editing program (for example, Movavi),
the minor category for the three-dimension in the medium category for the “program competency” in the major category includes 3ds Max, Maya, Autocad, Zbrush, Blender, Rhino, and C4D,
the minor category for the design in the medium category for the “professional competency” in the major category includes editorial design, package design, proposal (report) design, web design, app design, UI design, content design, product design, PPT design, character design, icon design, animation design, video design, typography, and figma,
the minor categories for the planning capability in the medium category for the “professional competency” in the major category includes content planning, card news planning, UX design, video planning, and business planning,
the minor category for the writing skill in the medium category for the “professional competency” in the major category includes report, business plan, thesis, press data, content manuscript, storytelling, and blog/post,
the minor category for the typing in the medium category for the “professional competency” in the major category includes Korean typing (speed), Korean typing (accuracy), equation, English typing (speed), and English typing (accuracy),
the minor category for the SNS in the medium category for the “professional competency” in the major category includes Facebook, Instagram, Naver Blog, YouTube, and TikTok,
the minor category for the data research in the medium category for the “professional competency” in the major category includes overseas sites, domestic sites, Internet information search, theses, and reports, and
the minor category for the language competency in the medium category for the “professional competency” in the major category includes Korean, English, Chinese, Japanese, French, Spanish, and Vietnamese.
